(19) United States
(12) Patent Application Publication
(10) Pub. No.: US 2011/0023822 A1
(43) Pub. Date: Feb. 3, 2011

(54) Intelli-tach

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/462,193

(22) Filed: Jul. 31, 2009

(51) Int. Cl. F02P 9/00; G06F 19/00

(52) U.S. Cl. 123/335; 701/102

(57) ABSTRACT

An electronic means for monitoring and controlling engine performance. The device takes input signals from vehicle engine speed sensor and ignition values. The electronic means is capable of recording an RPM event, and playing it back on the existing vehicle tachometer. Either the entire RPM event may be replayed, or the highest RPM value achieved during the event. Furthermore, the electronic means comprises a dial to set the RPM limit of an engine to prevent over-revving. Once the engine reaches the maximum user-defined RPM value, the electronic means interrupts the ignition system to prevent the engine from revving above such pre-determined value. The electronic means further comprises a shift light which illuminates once an engine reaches a pre-determined RPM value in order to alert the driver to shift gears.

### BACKGROUND OF THE INVENTION

1. Technical Field of the Invention

The present invention generally relates to electronic means for controlling and displaying engine RPM, and more particularly, to electronic means capable of setting engine RPM limit, recording RPM values, and playing back the recorded RPM values on the existing vehicle tachometer.

2. Description of the Background Art

Monitoring and controlling various engine parameters is highly important, whether it is in everyday driving situations or high-speed racing applications. Knowing whether an engine is optimally tuned is essential for increasing its longevity and decreasing the number of breakdowns. Various solutions have been attempted to offer the user a number of different ways to monitor engine performance. Tachometers have been long known to provide the driver with information about instantaneous engine speed. Whether in digital or analog form, tachometers are most often used to determine optimal shifting points for a given engine RPM. Typically, tachometers comprise a circular display with a graduated scale at the perimeter of the display. The graduated scale indicates the engine operating speed. In normal driving situations, the tachometer can be used to determine the optimal engine speed at which the transmission should be shifted to achieve the optimal fuel economy. Alternately, in racing applications, drivers use tachometers to ensure the engine is not “over-revved” as well as to determine shifting points corresponding to the RPM value at which peak engine power is produced.

Another common solution for controlling the engine operation is an engine RPM limiter. Such devices are used to set the maximum RPM value that an engine may reach, and once that threshold is reached, the device prevents the engine from achieving higher RPM by limiting the fuel supply or cutting the power supplied to the spark plugs. RPM limiters can prevent engine damage by preventing its operation above a pre-determined maximum value. Typically, these devices are located in the engine compartment of a vehicle, and are typically adjusted using a rotary knob, dip switch or a similar adjusting mechanism.

There exist a plurality of devices useful in controlling and monitoring engine operating speed. A common solution is illustrated in U.S. Pat. No. 4,281,388 to Friend et al., which teaches a tachometer for monitoring several functions of a vehicle, such as engine, shaft or ground speeds. A microprocessor receives input signals which vary in frequency according to variations in engine operating speed.

U.S. Pat. No. 4,262,641 to Mosely et al. teaches a multi-function device which uses a frequency-to-voltage converted signal to display the engine RPM values. The device further comprises a RPM limiter utilized to control engine ignition pulses and thereby limit the engine speed as it reaches a pre-determined maximum.

U.S. Pat. No. 5,982,168 to Westberg et al., which teaches a high-performance tachometer connected to an input signal. The device comprises a memory device capable of recording RPM values, such as during a drag-racing run. The recorded RPM values are stored and can be played back.

A number of problems are associated with these existing devices. For instance, rather than utilizing an existing vehicle tachometer, such devices usually necessitate installing an additional tachometer, which unnecessarily increase the complexity of installation as well as the cost of the equipment. Furthermore, RPM limiters that are located in engine compartments are cumbersome to adjust because they require the driver to leave the vehicle every time an adjustment is needed. The owner cannot verify functionality of the device if it is installed inside an engine compartment. Furthermore, such RPM limiters are often installed directly on engines, and therefore are exposed to harsh engine vibration. Such exposure to excessive vibration often causes de-seating of the set-points, thereby increasing or decreasing the RPM limit from the value originally selected.

While features taught in the prior art are incorporated into this invention, other elements are different enough so as to make the combination distinguished over the prior art. The electronic means for controlling and monitoring engine performance according to the present invention incorporates an RPM limiter to prevent the engine from revving over a pre-determined value. Furthermore, the present invention incorporates a shift-light activated at a pre-determined RPM value in order to alert the driver to change gears. There exists no known electronic means for controlling and monitoring engine RPM comprising the features and the capabilities taught by the present invention.

### SUMMARY OF THE INVENTION

It is therefore an object of the present invention to provide an electronic means for controlling and monitoring engine performance.

It is another object of the present invention to provide an electronic means for controlling and monitoring engine performance having the capability of setting the engine RPM limit.

Yet another object of the present invention is to provide an electronic means for controlling and monitoring engine performance having the capability of recording an engine event, and replying that event at a later time.

An additional object of the present invention is to provide an electronic means for controlling and monitoring engine performance having the capability to recall the highest RPM value during a particular period of time.

A further feature of the present invention is to provide an electronic means for controlling and monitoring engine performance having a visual output means that is activated once the engine reaches a pre-determined RPM value to prompt the driver to shift gears.

Another object of the present invention is to provide an electronic means for controlling and monitoring engine performance that is useful in informing the driver about optimum gear shifting points.

It is a final object of the present invention to provide all of the benefits the foregoing objects entail.

Briefly described according to one embodiment of the present invention, an electronic means utilizes the signal sent to an existing vehicle tachometer. The electronic signal changes frequency as the engine speed changes. The electronic signal is routed through the electronic means. A first mode button is used to sequence through the different programming/set modes and a second button is used to set the value up and down. When the user wants to program the ‘rev limit’, for example, the “mode button” held until an LED indicator is lit up for rev limit, at which time the microprocessor will then stop sending the engine rpm data straight through to the tachometer and instead send an RPM equivalent of what rpm the user wants the rev limit to be set at. If the user does not like the current setting, he will merely push an up or down button until the tach pointer on his already existing tachometer reaches the desired limit. this is the case for any electronic engine activated/control device. Contrary to the dials, pushbuttons, dip switches, digital readouts, etc, of the existing art, the present invention is programmed by using pushbuttons and displays the information on the tachometer instead of separate means. When the electronic means is not in use, the signal simply carries the value corresponding to the instantaneous engine RPM. When the electronic means is activated to record an engine event, the signal is stored on the built-in memory for later replay. The recorded engine event is capable of being replayed through the existing vehicle tachometer. Additionally, the existing vehicle tachometer is also used to display the highest RPM value that an engine achieves by displaying

Additional features and advantages of the present inventions will be set forth in part in the following description and claims. The features and advantages of the preferred embodiment will be realized by means of the elements and combinations specifically pointed out in the claims. It is to be understood that the following description, drawings, and claims are exemplary only and are not restrictive or limiting of the present invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the electronic means for monitoring and controlling engine performance installed on a vehicle dash;

FIG. 2 is a frontal view of the electronic means used to monitor and control engine performance according to the preferred embodiment of the present invention; and

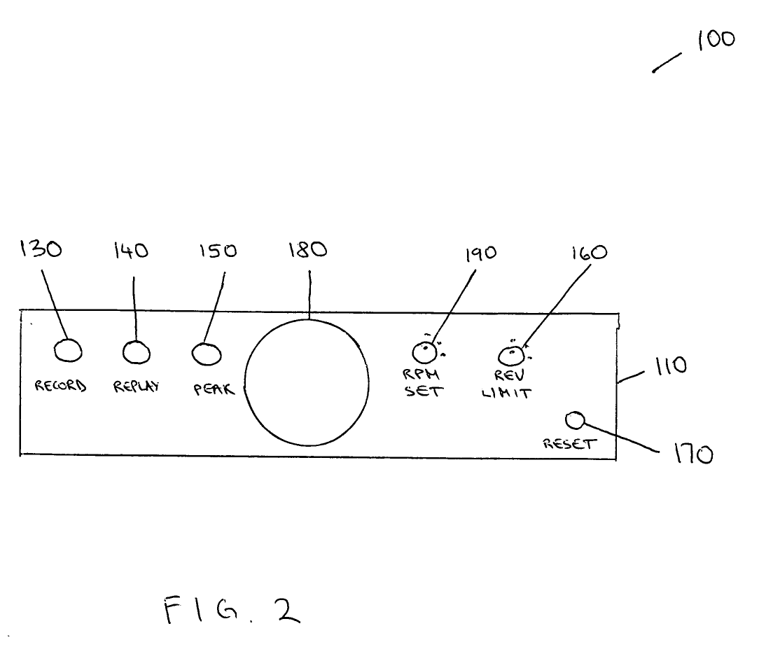

FIG. 3 is a block diagram showing the functional components of the preferred embodiment of the present invention.

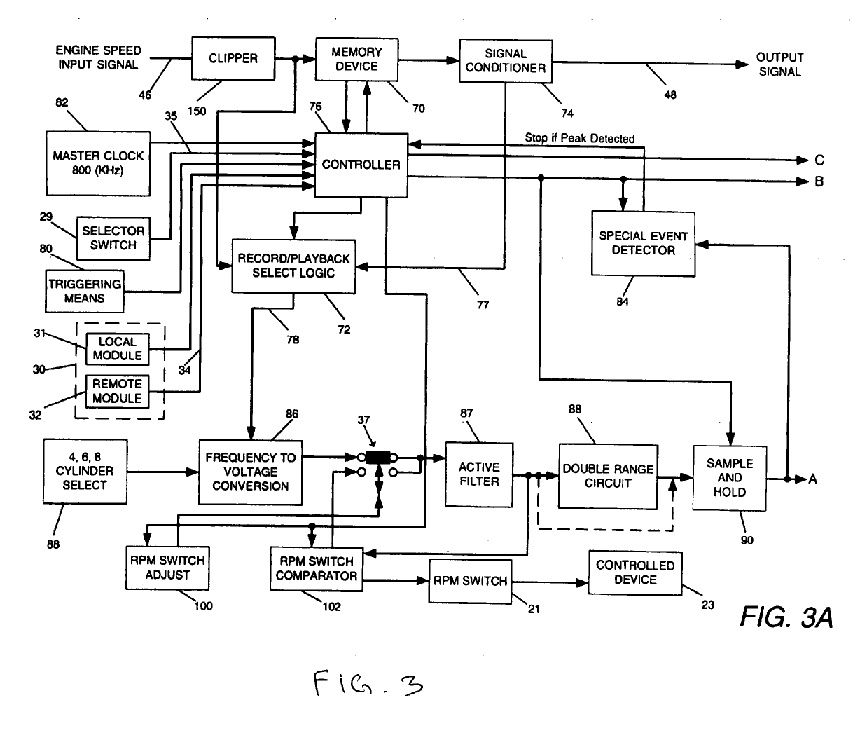

### DETAILED DESCRIPTION OF THE PREFERRED EMBODIMENTS

The best mode for carrying out the invention is presented in terms of its preferred embodiment, herein depicted within the Figures.

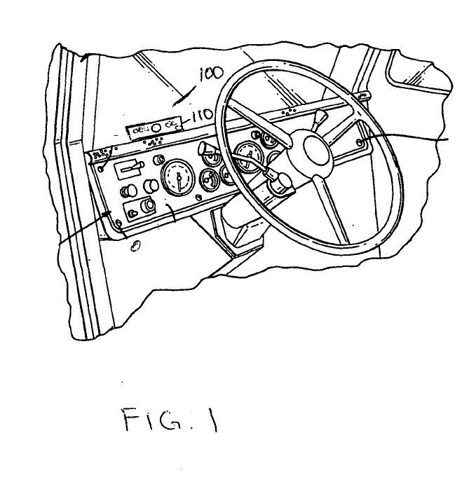

Examples of the preferred embodiments of the present invention are shown in the figures, but these examples do not limit the present invention to only those expressions shown. An electronic means for controlling and monitoring engine performance 100 is shown in FIG. 1.

As shown in FIG. 1, the electronic means for controlling and monitoring engine performance 100 generally comprises a rectangular housing 110. The housing 110 is preferably manufactured from a hard plastic material, such as ABS or polycarbonate; however, the use of other materials is not precluded. For example, the housing 110 may be manufactured from metal, carbon fiber, other similar materials, or any combination thereof One of ordinary skill in the art will realize that the material selection for the housing 110 is not a limiting factor of the present invention. The housing 110 is preferably mounted to a location in the vehicle such that it is both visible to the driver at all times and is within reach. For example, the housing 110 may be mounted to the top of the dash in an automobile, using mechanical attachment means, such as screws or adhesive strips. Alternately, the housing 110 may be installed on a bracket (not shown).

The housing 110 contains the electronic circuitry necessary to operate the electronic means 100. The electronic means 100 connects to the existing vehicle tachometer by routing the signal sent from the engine speed sensor through the electronic means 100. Additionally, the electronic means 100 connects to the vehicle's electronic control unit (ECU), in order to receive signals from the vehicle's ignition system. It is anticipated that the electronic means 100 offers a “plug and play” operation. In other words, the user simply intercepts the signal going into the existing vehicle tachometer and relays it through the electronic means. During regular operation, the existing vehicle tachometer functions in a conventional manner as it would without the electronic means 100 connected.

Also shown in FIG. 1 are various driver controls 120. The controls are segmented to provide recording/playback operation and RPM limiter operation. For enabling recording and playback functions, the electronic means 100 comprises a plurality of buttons which activate various functions of the memory. For instance, the “RECORD” button 130 puts the device in the recording mode. For a user-defined length of time, such as a typical quarter-mile drag race, the electronic device 100 records and stores all of the RPM values. After the run is over and the vehicle is stationary, the user may review the engine performance by pressing the “REPLAY” button 140. Once the “REPLAY” button 140 is activated, the electronic means 100 plays back the recorded sequence of RPM values on the existing vehicle tachometer. The driver may use these values, such as maximum RPM and shifting points, to assess his/her driving skill as well as engine performance. Furthermore, the “PEAK” button 150 recalls and displays the highest RPM value that the engine reached during the recording period. The electronic device 100 may start to record the RPM event when the driver presses the “RECORD” button. Alternately, the RPM event may be initiated automatically, such as when the vehicle experiences a wide-open throttle condition.

The electronic means 100 further comprises a “REV LIMIT” 160 dial which allows the driver to control the vehicle's ignition system. The dial 160 permits the driver to set the maximum RPM limit before the electronic means 100 intervenes to cut off the ignition system and prevent the engine from revving beyond the pre-set value. The “RESET” button 170 resets all user-defined parameters and returns the vehicle to the stock mode.

Another feature of the present invention is an integral shift light 180. The shift light 180 illuminates at appropriate times to inform the driver to change gears. While the shift light 180 is described as being integral to the electronic means 100, it should be appreciated that the shift light could be separated and mounted in any other convenient location that provides optimal observance by the driver. The shift light 180 preferably comprises an LED or an incandescent light bulb that is illuminated once the engine reaches a predetermined RPM. For example, if the peak power output of an engine occurs at 7500 RPM, the driver may adjust the electronic means 100 such that the shift light illuminates every time the engine reaches 7500 RPM. The light preferably remains illuminated for all RPM values above the predetermined value. It is anticipated that the visual indication of an optimal shifting point allows the driver to focus on the task of driving rather than looking at the tachometer needle to reach the desired RPM value. The shift light 180 may be used to alert the driver about shifting points for maximum performance or maximum fuel economy. Additionally, the shift light 180 may also be combined with an auditory means (not shown) to further alert the driver about the optimal shifting point. The auditory means may emit the sound through a built-in speaker, or through the vehicle's sound system. The “RPM SET” dial 190 is used to set the RPM value at which the shift light 150 is triggered.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. An electronic means for controlling an engine RPM comprising:
Means for setting engine RPM limit, recording RPM values, and playing back the recorded RPM values on the existing vehicle tachometer;
Wherein a vehicles' preexisting tachometer is therein adapted to be used for providing input settings and output display for said means for setting RPM limit.

2. The electronic means for controlling an engine RPM of claim 1, wherein means for setting engine RPM limit comprises:
A sequence setting button is used to sequence through he different programming/set modes;
An up value button; and
A down value button.

3. An electronic means for controlling and monitoring engine performance comprising:
electronic means connecting to the existing vehicle tachometer for routing the signal sent from the engine speed sensor through the electronic means, said electronic means further connecting to a vehicle's electronic control unit (ECU) in order to receive signals from the vehicle's ignition system.

4. The electronic means for controlling and monitoring engine performance of claim 3, wherein said electronic means is adapted to be in electronic communication with the existing vehicle tachometer and thereby intercepts the signal going into the existing vehicle tachometer and relays it through the electronic means such that during regular operation, the existing vehicle tachometer functions in an otherwise conventional manner as it would without the electronic means connected.

5. The electronic means for controlling and monitoring engine performance of claim 4, further comprising driver controls segmented to provide recording/playback operation and RPM limiter operation.

6. The electronic means for controlling and monitoring engine performance of claim 4, said electronic means further comprising a plurality of controls for activating functions selected from the group comprising: a recording mode for recording and storing all of the RPM values; a playback mode for playing back the recorded sequence of RPM values on the existing vehicle tachometer; a peak mode for recalling and displaying the highest RPM value that the engine reached during the recording period; and a mode to permit the driver to set the maximum RPM limit before the electronic means intervenes to cut off the ignition system and prevent the engine from revving beyond the pre-set value.

7. The electronic means for controlling and monitoring engine performance of claim 4, said electronic means further comprising a shift light for illuminating at appropriate times to inform the driver to change gears.

8. The electronic means for controlling and monitoring engine performance of claim 7, wherein said shift light is capable of being separately and mounted in any other convenient location that provides optimal observance by the driver.

9. The electronic means for controlling and monitoring engine performance of claim 7, wherein said shift light comprises an LED or an incandescent light bulb that is illuminated once the engine reaches a predetermined RPM.
